(19) United States
(12) Patent Application Publication
(10) Pub. No.: US 2026/0170703 A1
(43) Pub. Date: Jun. 18, 2026

(54) COMPUTILITY SETTING METHOD AND IMAGE PROCESSING SYSTEM

(71) Applicant: MEDIATEK INC., Hsinchu City (TW)

(72) Inventors: Yen-An Shih, Hsinchu City (TW); Kan-Yao Chang, Hsinchu City (TW); Nien-Hsien Lin, Hsinchu City (TW); Cheng-Han Tsai, Hsinchu City (TW); Cheng-Che Chen, Hsinchu City (TW)

(73) Assignee: MEDIATEK INC., Hsinchu City (TW)

(21) Appl. No.: 18/979,671

(22) Filed: Dec. 13, 2024

(51) Int. Cl. G06T 11/00; G06T 1/20

(52) U.S. Cl. CPC G06T 11/00; G06T 1/20

(57) ABSTRACT

A computility setting method, comprising: (a) the processing circuit alternatively outputting the frame information of at least one type one frame and of at least type two frame; and (b) setting a computility of the processing circuit for a next frame according to a first computility used by the processing circuit in a time interval related with time of outputting the frame information of the type one frame but not according to a second computility used by the processing circuit in a time interval related with time of outputting the frame information of the type two frame, or setting the computility of the processing circuit according to the second computility but not according to the first computility. The required computility of the type two frame is lower than which of the type one frame.

### BACKGROUND

The present application relates to a computility setting method and an image generating system, and particularly relates to a computility setting method and an image generating system which can set a computility of the processing circuit more accurately.

The MEMC (motion estimation and motion compensation) algorithm is a popular image compensation algorithm. The MEMC algorithm may redraw the frame that needs to be inserted, and the required computility for the inserted frame will be different from the original frame. Since the required computility for a next frame may be anticipated by the required computility of at least one previous frame, the combined use of original frames and inserted frames may cause improper computility settings.

Accordingly, a new computility setting is needed.

### SUMMARY

One objective of the present application is to provide a computility setting method which can set a proper computility of a processing circuit.

Another objective of the present application is to provide a computility setting method which can set a proper computility of a processing circuit.

One embodiment of the present application is to provide a computility setting method, applied to an image generating system comprising a processing circuit and a graphic circuit, the processing circuit providing frame information to the graphic circuit, the computility setting method comprising: (a) the processing circuit alternatively outputting the frame information of at least one type one frame and the frame information of at least type two frame; and (b) setting a computility of the processing circuit for a next frame according to a first computility used by the processing circuit in a time interval related with time of outputting the frame information of the type one frame but not according to a second computility used by the processing circuit in a time interval related with time of outputting the frame information of the type two frame, or setting the computility of the processing circuit according to the second computility but not according to the first computility; wherein processing of the frame information of the type one frame requires a first required computility of the processing circuit, and processing of the frame information of the type two frame requires a second required computility of the processing circuit, wherein the second required computility is lower than the first required computility.

Another embodiment of the present application discloses an image processing system, comprising: a graphic circuit, configured to generate a frame according to frame information; and a processing circuit, configured to output the frame information, and configured to perform followings steps: (a) the processing circuit alternatively outputting the frame information of at least one type one frame and the frame information of at least type two frame; and (b) setting a computility of the processing circuit for a next frame according to a first computility used by the processing circuit in a time interval related with time of outputting the frame information of the type one frame but not according to a second computility used by the processing circuit in a time interval related with time of outputting the frame information of the type two frame, or setting the computility of the processing circuit according to the second computility but not according to the first computility; wherein processing of the frame information of the type one frame requires a first required computility of the processing circuit, and processing of the frame information of the type two frame requires a second required computility of the processing circuit, wherein the second required computility is lower than the first required computility.

In view of above-mentioned embodiments, the next computility is computed according to computility for frame information of frames with the same type rather than frames with different types, thus the computation of the next computility can be more accurate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an image processing system according to one embodiment of the present application.

FIG. 2 is a schematic diagram illustrating detail operations of setting a computility of the processing circuit, according to one embodiment of the present application.

FIG. 3 is a schematic diagrams illustrating detail operations of setting a computility of the processing circuit, according to another embodiment of the present application.

FIG. 4 is a flow chart illustrating operations of the embodiments illustrated in FIG. 2 and FIG. 3, according to one embodiment of the present application.

FIG. 5 is a schematic diagram illustrating the operation of computing a computility of a previous frame, according to one embodiment of the present application.

FIG. 6 is a flow chart illustrating a computility setting method, according to one embodiment of the present application.

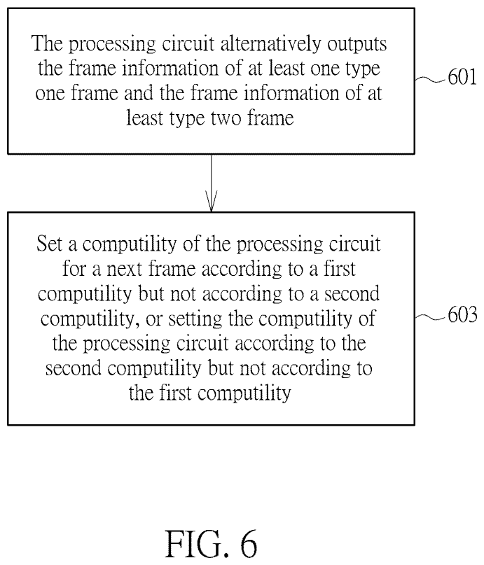

### DETAILED DESCRIPTION

Several embodiments are provided in following descriptions to explain the concept of the present invention. The method in following descriptions can be performed by programs stored in a non-transitory computer readable recording medium by a processing circuit. The non-transitory computer readable recording medium can be, for example, a hard disk, an optical disc or a memory. Also, the term “first”, “second”, “third” in following descriptions are only for the purpose of distinguishing different one elements, and do not mean the sequence of the elements. For example, a first device and a second device only mean these devices can have the same structure but are different devices.

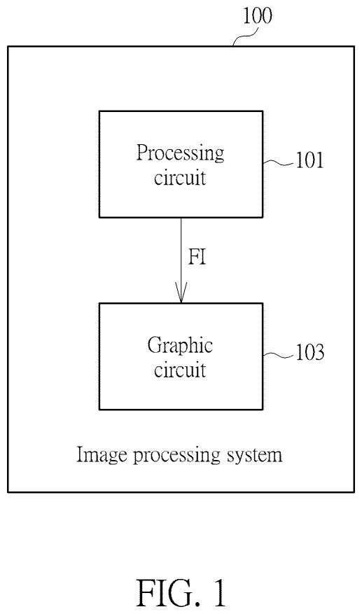

FIG. 1 is a block diagram illustrating an image processing system 100 according to one embodiment of the present application. As shown in FIG. 1, the image processing system 100 comprises a processing circuit 101 and a graphic circuit 103. In one embodiment, the processing circuit 101 is a CPU (Central Processing Unit) and the graphic circuit 103 is a GPU (Graphics Processing Unit), but other circuits or devices which can provide similar functions should also fall in the scope of the present application. The processing circuit 101 is configured to provide frame information FI to the graphic circuit 103, thus the graphic circuit 103 can generate frames based on the frame information FI. For example, the graphic circuit 103 may render frames based on the frame information provided by the processing circuit 101. In such case, the processing circuit 101 may also provide instructions to the graphic circuit 103.

Please note, the operation “provide frame information FI to the graphic circuit 103” may mean directly providing or indirectly providing. For directly providing, the processing circuit 101 may directly outputs the frame information FI to the graphic circuit 103. For indirectly providing, the processing circuit 101 may output the frame information FI to a buffer first, and then the buffered frame information FI is transmitted to the graphic circuit 103. The operations between the processing circuit 101 and the graphic circuit 103 may be different due to different designs thereof. Also, the contents of the frame information FI may be different due to different designs of the processing circuit 101 and the graphic circuit 103.

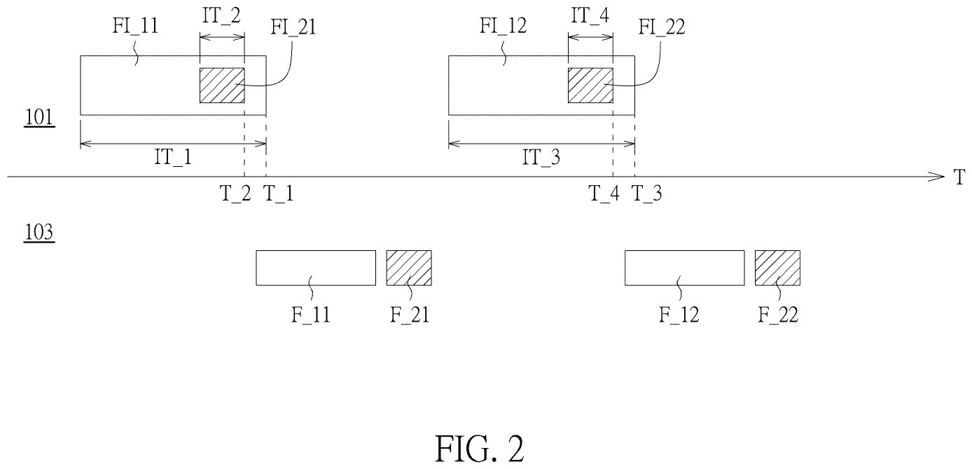

In the embodiment of FIG. 1, the processing circuit 101 alternatively outputs the frame information FI of at least one type one frame and the frame information FI of at least one type two frame. Then, a computility (or named as computing power) of the processing circuit 101 for a next frame is set according to a first computility used by the processing circuit 101 but not according to a second computility used by the processing circuit 101. For the convenience of explaining, the description “computility of the processing circuit 101 for a next frame” is abbreviated as “next computility” in following embodiments. In another embodiment, the next computility is set according to the second computility but not according to the first computility. Please note, the “next computility” mentioned in this embodiment means a computility of a next frame of the second type one frame F_12 in FIG. 2. However, the “next computility” may mean a computility of a next N frame of the second type one frame F_12 in some embodiments, where N is a positive integer larger than 1. The computility of the processing circuit 101 can set by executing at least one program by the processing circuit 101, but can be set by another circuit or another device independent from the processing circuit 101.

Computility may mean the efficacy of the processing circuit 101. For example, the computility may be the ability of processing circuit 101 to process tasks. The first computility is the computility used by the processing circuit 101 in a time interval related with time of outputting the frame information of the type one frame. The second computility is the computility used by the processing circuit 101 in a time interval related with time of outputting the frame information of the type two frame.

Processing of frame information of type one frames requires a first required computility of the processing circuit 101, and processing of frame information of type two frames requires a second required computility of the processing circuit 101, wherein the second required computility is lower than the first required computility. In one embodiment, each one of the type two frames is generated by a MEMC (motion estimation and motion compensation) algorithm to compensate the type one frames. For example, the type one frames are original frames and type two frames are inserted frames generated by the MEMC algorithm.

Details of setting the next computility will be described in following embodiments. FIG. 2 is a schematic diagram illustrating detail operations of setting a computility of the processing circuit, according to one embodiment of the present application. In the embodiment of FIG. 2, the processing circuit 101 outputs first frame information FI_11 of a first type one frame F_11 in a first time interval IT_1, and completes outputting of the first frame information FI_11 at a first time T_1. Also, the processing circuit 101 outputs second frame information FI_21 of a first type two frame F_21 in a second time interval IT_2, and completes outputting of the second frame information IT_2 at a second time T_2. In one embodiment, at least a portion of the second time interval IT_2 is overlapped with the first time interval IT_1. However, the second time interval IT_2 and the first time interval IT_1 can be non-overlapped. In the embodiment of FIG. 2, the second time interval IT_2 is fully contained in the first time interval IT_1. As shown in FIG. 2, the graphic circuit 103 processes the first type one frame F_11 based on the first frame information FI_11 and processes the first type two frame F_21 based on the second frame information FI_21.

Similarly, the processing circuit 101 outputs third frame information FI_12 of a second type one frame F_12 in a third time interval IT_3, and completes outputting of the third frame information FI_12 at a third time T_3 after the first time T_1 and the second time T_2. Further, the processing circuit 101 outputs fourth frame information FI_22 of a second type two frame F_22 in a fourth time interval IT_4, and completes outputting of the fourth frame information FI_22 at a fourth time T_4 after the first time T_1 and the second time T_2.

In one embodiment, at least a portion of the fourth time interval IT_4 is overlapped with the third time interval IT_3. However, the third time interval IT_3 and the fourth time interval IT_4 can be non-overlapped. In the embodiment of FIG. 2, the fourth time interval IT_4 is fully contained in the third time interval IT_3. As shown in FIG. 2, the graphic circuit 103 generates the second type one frame F_12 based on the frame information FI_12 and generates the second type two frame F_22 based on the frame information FI_22.

In the embodiment of FIG. 2, the above-mentioned first computility is the computility used by the processing circuit in a first time difference and the above-mentioned second computility is the computility used by the processing circuit in a second time difference. The first time difference is a time difference between the first time T_1 and the third time T_3 and the second time difference is a time difference between the second time T_2 and the fourth time T_4. The next computility of the processing circuit 101 is set according to the first computility but not according to the second computility, or the computility of the processing circuit 101 is set according to the second computility but not according to the first computility.

In other words, as stated above, the next computility is set according to a first computility used by the processing circuit 101 but not according to a second computility used by the processing circuit 101. In another embodiment, the next computility is set according to the second computility but not according to the first computility. The first computility is used by the processing circuit 101 in a time interval related with time of outputting the frame information of the type one frame (e.g., the first time difference between the first time T_1 and the third time T_3). The second computility is used by the processing circuit 101 in a time interval related with time of outputting the frame information of the type two frame (e.g., the second time difference between the second time T_2 and the fourth time T_4).

In the embodiment of FIG. 2, the second type one frame F_12 is a next frame of the first type one frame F_11, and the second type two frame F_22 is a next frame of the first type two frame F_21. Accordingly, the processing circuit 101 does not output frame information of any other type one frame between the first time T_1 and the third time T_3, and does not output frame information of any other type two frame between the second time T_2 and the fourth time T_4. In other words, the next computility may be set according to a computation used in a time interval, which is related with outputting time of frame information of two consecutive frames of the same type.

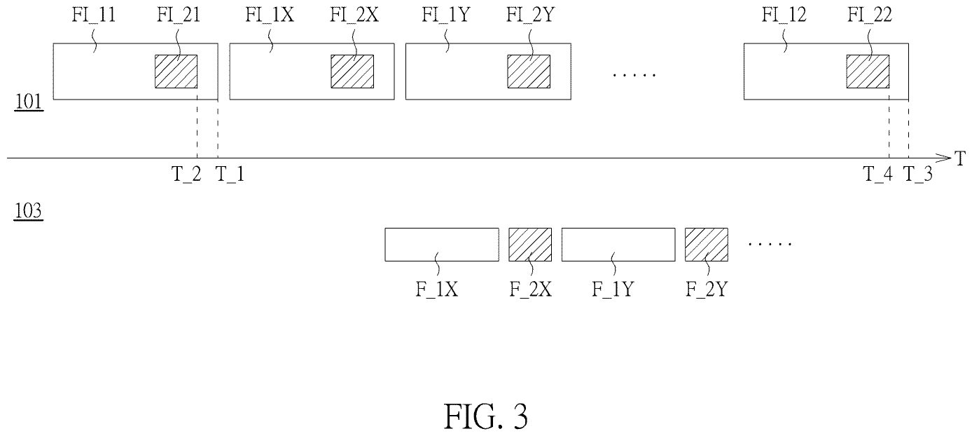

FIG. 3 is a schematic diagram illustrating detail operations of setting a computility of the processing circuit, according to another embodiment of the present application. Please note, in the embodiment of FIG. 3, for the simplicity of illustration, some operations of the graphic circuit 103 are not illustrated.

In the embodiment of FIG. 3, at least one type one frame exists between the first type one frame F_11 and the second type one frame F_12. For example, type one frames F_1X and F_1Y exist between the first type one frame F_11 and the second type one frame F_12. Accordingly, frame information FI_1X and FI_1Y respectively of type one frames F_1X and F_1Y are output by the processing circuit 101 between the first time T_1 and the third time T_3. Similarly, at least one type two frame exists between the first type two frame F_21 and the second type two frame F_22. For example, type two frames F_2X and F_2Y exist between the first type two frame F_21 and the second type two frame F_22. Accordingly, frame information FI_2X and FI_2Y respectively of type two frames F_2X and F_2Y are output by the processing circuit 101 between the second time T_2 and the fourth time T_4. The graphic circuit 103 processes the type one frames F_1X and F_1Y respectively based on the frame information FI_1X and FI_1Y, and processes the type two frames F_2X and F_2Y respectively based on the frame information FI_2X and FI_2Y.

In the embodiment of FIG. 3, the above-mentioned first computility is the computility used by the processing circuit 101 in a first time difference and the above-mentioned second computility is the computility used by the processing circuit 101 in a second time difference. The first time difference is still a time difference between the first time T_1 and the third time T_3 and the second time difference is still a time difference between the second time T_2 and the fourth time T_4. The next computility of the processing circuit 101 is set according to the first computility but not according to the second computility, or the computility of the processing circuit 101 is set according to the second computility but not according to the first computility.

In other words, as stated above, the next computility is set according to a first computility used by the processing circuit 101 but not according to a second computility used by the processing circuit 101. In another embodiment, the next computility is set according to the second computility but not according to the first computility. The first computility is used by the processing circuit 101 in a time interval related with time of outputting the frame information of the type one frame (e.g., the first time difference between the first time T_1 and the third time T_3). The second computility is used by the processing circuit 101 in a time interval related with time of outputting the frame information of the type two frame (e.g., the second time difference between the second time T_2 and the fourth time T_4).

As stated above, in the embodiment of FIG. 3, at least one type one frame exists between the first type one frame F_11 and the second type one frame F_12 and at least one type two frame exists between the first type two frame F_21 and the second type two frame F_22. Accordingly, the processing circuit 101 outputs frame information of at least one of the type one frame between the first time T_1 and the third time T_3, and outputs frame information of at least one of the type two frame between the second time T_2 and the fourth time T_4. In other words, the next computility may be set according to a computation used in a time interval, which is related with outputting time of frame information of two frames of the same type. However, at least one frame of the same type exists between these two frames.

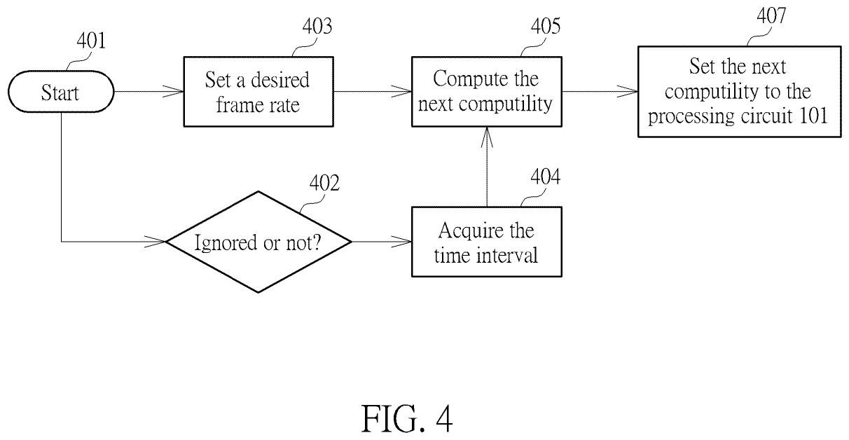

FIG. 4 is a flow chart illustrating operations of the embodiments illustrated in FIG. 2 and FIG. 3, according to one embodiment of the present application. FIG. 4 comprises following steps:

### Step 401

Start a procedure of generating type two frames.

For example, the MEMC algorithm is started. Accordingly, in the step 401, the computation of the next computility also starts.

### Step 402

Is the time for outputting frame information ignored or not?

For example, in the embodiment of FIG. 2, if the next computility is computed according to the computility used between the first time T_1 and the third time T_3, the second time T_2 and the fourth time T_4 will be ignored. On the opposite, if the next computility is computed according to the computility used between the second time T_2 and the fourth time T_4, the first time T_1 and the third time T_3 will be ignored.

In one embodiment, the output time of frame information are ignored according to whether the corresponding frame is an odd frame or an even frame. For example, in the embodiment of FIG. 2, the first type one frame F_11 and the second type one frame F_12 are odd frames and the first type two frame F_21 and the second type two frame F_22 are even frames. Accordingly, if the next computility is computed according to the computility used between the first time T_1 and the third time T_3, the output time of frame information of the even frames are ignored. Oppositely, if the next computility is computed according to the computility used between the second time T_2 and the fourth time T_4, the output time of frame information of the odd frames are ignored.

### Step 403

Set a desired frame rate of the type one frames, to keep the frame rate at a constant frame rate.

For example, if the frame rate is initially 60 FPS when no type two frame is generated and only the type one frames exist, the desired frame rate of the type one frames is set to be 30 FPS since the number of the total frames becomes two times after the type two frames are generated.

### Step 404

Acquire the time interval for computing the next computility.

For example, if output time of frame information of the even frames are ignored in the step 402, the time interval is T_1-T_3 (i.e., the above-mentioned first time difference).

The step 403 may be performed at the same time of the step 404 or at different time of the step 404.

### Step 405

Compute the next computility according to the information provided by the step 403 and the step 404.

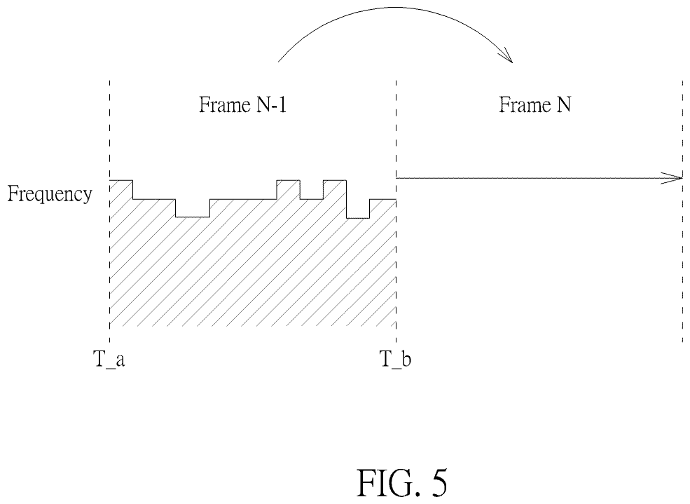

One example of the step 405 will be described in the example of FIG. 5.

### Step 407

Set the next computility to the processing circuit 101.

FIG. 5 is a schematic diagram illustrating the operation of computing the computility of a previous image, according to one embodiment of the present application. In FIG. 5, the X axis means time and the Y axis means a frequency of the processing circuit. Also, the slash region means the computility used in a time interval of T_a-T_b.

In one embodiment, the next computility is computed using following Equation (1):

$$SR \times \frac{T\_R}{T\_a - T\_b} \times \frac{1}{fps\_e} \qquad Equation ( 1 )$$

SR is the slash region illustrated in FIG. 5, which can be acquired by repeatedly using “multiplying the frequency with time” to acquire areas of all small regions of the whole slash region. These areas are summed to acquire SR. T_a−T_b is the time interval acquired in the step 404 in FIG. 4. T_R is time for at least one task which is related to graphic processing while processing the frame information of the frame N−1.

Accordingly, the step of

$$SR \times \frac{T\_R}{T\_a - T\_b}$$

can be regarded as: ignore at least one computility for at least one task which is not related to graphic processing while computing the first computility or the second computility. Fps e is the desired frame rate set in step 403. After the computility of the processing circuit 101, which is used for frame N−1, has been computed, the computility of the processing circuit 101, which is used for frame N, can be set accordingly. In one embodiment, the computility of the processing circuit 101 is set by setting the frequency thereof.

In view of above-mentioned embodiments, a computility setting method can be acquired. The computility setting method can be applied to an image generating system comprising a processing circuit and a graphic circuit, such as the image generating system 100 illustrated in FIG. 1. The computility setting method comprises:

### Step 601

The processing circuit alternatively outputs the frame information of at least one type one frame and the frame information of at least type two frame, such as the embodiment shown in FIG. 2.

### Step 603

Set a computility of the processing circuit for a next frame according to a first computility used by the processing circuit in a time interval related with time of outputting the frame information of the type one frame (e.g., the first time difference between the first time T_1 and the second time T_2) but not according to a second computility used by the processing circuit in a time interval related with time of outputting the frame information of the type two frame (e.g., the third time difference between the third time T_3 and the fourth time T_4), or setting the computility of the processing circuit according to the second computility but not according to the first computility.

Processing of frame information of the type one frame requires a first required computility y of the processing circuit, and processing of frame information of the type two frame requires a second required computility of the processing circuit. The second required computility is lower than the first required computility.

In view of above-mentioned embodiments, the next computility is computed according to computility for frame information of frames with the same type rather than frames with different types, thus the computation of the next computility can be more accurate.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computility setting method, applied to an image generating system comprising a processing circuit and a graphic circuit, the processing circuit providing frame information to the graphic circuit, the computility setting method comprising:
(a) the processing circuit alternatively outputting the frame information of at least one type one frame and the frame information of at least one type two frame; and
(b) setting a computility of the processing circuit for a next frame according to a first computility used by the processing circuit in a time interval related with time of outputting the frame information of the type one frame but not according to a second computility used by the processing circuit in a time interval related with time of outputting the frame information of the type two frame, or setting the computility of the processing circuit according to the second computility but not according to the first computility;
wherein processing of the frame information of the type one frame requires a first required computility of the processing circuit, and processing of the frame information of the type two frame requires a second required computility of the processing circuit, wherein the second required computility is lower than the first required computility.

2. The computility setting method of claim 1,
wherein the step (a) comprises:
the processing circuit outputting first frame information of a first type one frame in a first time interval, and completes outputting of the first frame information at a first time;
the processing circuit outputting second frame information of a first type two frame in a second time interval, and completes outputting of the second frame information at a second time;
the processing circuit outputting third frame information of a second type one frame in a third time interval, and completes outputting of the third frame information at a third time after the first time and the second time;
the processing circuit outputting fourth frame information of a second type two frame in a fourth time interval, and completes outputting of the fourth frame information at a fourth time after the first time and the second time;
wherein the step (b) comprises:
setting the computility of the processing circuit according to the first computility used by the processing circuit in a first time difference but not according to the second computility used by the processing circuit in a second time difference, or setting the computility of the processing circuit according to the second computility but not according to the first computility, wherein the first time difference is a time difference between the first time and the third time and the second time difference is a time difference between the second time and the fourth time.

3. The computility setting method of claim 2, wherein the processing circuit does not output frame information of any other one of the type one frame between the first time and the third time, and does not output frame information of any other one of the type two frame between the second time and the fourth time.

4. The computility setting method of claim 2, wherein the processing circuit outputs frame information of at least one of the type one frame between the first time and the third time, and outputs frame information of at least one of the type two frame between the second time and the fourth time.

5. The computility setting method of claim 2, wherein the second time interval is contained in the first time interval, and the fourth time interval is contained in the third time interval.

6. The computility setting method of claim 1, wherein the processing circuit is a CPU (Central Processing Unit) and the graphic circuit is a GPU (Graphics Processing Unit).

7. The computility setting method of claim 1, wherein each one of the type two: frame is generated by a MEMC (motion estimation and motion compensation) algorithm to compensate the type one frame.

8. The computility setting method of claim 1, wherein the step (b) ignores at least one computility for at least one task which is not related to graphic processing while computing the first computility or the second computility.

9. An image processing system, comprising:
a graphic circuit, configured to generate a frame according to frame information; and
a processing circuit, configured to output the frame information, and configured to perform followings steps:
(a) the processing circuit alternatively outputting the frame information of at least one type one frame and the frame information of at least type two frame; and
(b) setting a computility of the processing circuit for a next frame according to a first computility used by the processing circuit in a time interval related with time of outputting the frame information of the type one frame but not according to a second computility used by the processing circuit in a time interval related with time of outputting the frame information of the type two frame, or setting the computility of the processing circuit according to the second computility but not according to the first computility;
wherein processing of the frame information of the type one frame requires a first required computility of the processing circuit, and processing of the frame information of the type two frame requires a second required computility of the processing circuit, wherein the second required computility is lower than the first required computility.

10. The image generating system of claim 9,
wherein the step (a) comprises:
the processing circuit outputting first frame information of a first type one frame in a first time interval, and completes outputting of the first frame information at a first time;
the processing circuit outputting second frame information of a first type two frame in a second time interval, and completes outputting of the second frame information at a second time;
the processing circuit outputting third frame information of a second type one frame in a third time interval, and completes outputting of the third frame information at a third time after the first time and the second time;
the processing circuit outputting fourth frame information of a second type two frame in a fourth time interval, and completes outputting of the fourth frame information at a fourth time after the first time and the second time;
wherein the step (b) comprises:
setting the computility of the processing circuit according to the first computility used by the processing circuit in a first time difference but not according to the second computility used by the processing circuit in the second time difference, or setting the computility of the processing circuit according to the second computility but not according to the first computility, wherein the first time difference is a time difference between the first time and the third time and the second time difference is a time difference between the second time and the fourth time.

11. The image generating system of claim 10, wherein the processing circuit does not output frame information of any other one of the type one frame between the first time and the third time, and does not output frame information of any other one of the type two frame between the second time and the fourth time.

12. The image generating system of claim 10, wherein the processing circuit outputs frame information of at least one of the type one frame between the first time and the third time, and outputs frame information of at least one of the type two frame between the second time and the fourth time.

13. The image generating system of claim 10, wherein the second time interval is contained in the first time interval, and the fourth time interval is contained in the third time interval.

14. The image generating system of claim 9, wherein the processing circuit is a CPU (Central Processing Unit) and the graphic circuit is a GPU (Graphics Processing Unit).

15. The image generating system of claim 9, wherein each one of the type two frame is generated by a MEMC (motion estimation and motion compensation) algorithm to compensate the type one frame.

16. The image generating system of claim 9, wherein the step (b) ignores at least one computility for at least one task which is not related to graphic processing while computing the first computility or the second computility.
